(19) United States
(12) Patent Application Publication
(10) Pub. No.: US 2007/0179750 A1
(43) Pub. Date: Aug. 2, 2007

(54) Information partner network

(75) Inventor: Craig Burfeind, Chanhassen, MN (US)

Correspondence Address: DIGITAL CYCLONE, INC.;c/o GARMIN INTERNATIONAL, INC., 1200 EAST 151ST STREET, ATTN: LEGAL - IP, OLATHE, KS, 66062, US

(73) Assignee: Digital Cyclone, Inc.

(21) Appl. No.: 11/343,659

(22) Filed: Jan. 31, 2006

(51) Int. Cl. G06F 11/00; G06F 15/00

(52) U.S. Cl. 702/188

(57) ABSTRACT

An information distribution system includes at least a first partner device and a second partner device. The first partner device is configured to execute partner software including an obtain module and a transmit module. The obtain module configured to obtain information from surroundings of the first partner device and the transmit module configured to transmit the obtained information. The second partner device is configured to execute partner software including a receive module and a display module. The receive module is configured to receive the information transmitted by the first partner device and the display module is configured to display the information received from the first partner device.

### BACKGROUND

In recent years, the distribution of current, location-specific information has become increasingly important to people and organizations. Location-specific information includes news-type information, weather reports and forecasts, traffic conditions, newsworthy events, and other types of information pertaining to a particular location. Location-specific information also includes still pictures, sound, and video taken at a particular location.

The Internet has become a widely used source for distributing all types of information. The Internet hosts an extensive user community and enables the exchange of information to any networked computer. The Internet can be accessed from client computer systems via a telephone line connection and dial-up modem, a dedicated line, a cable access line, a wireless system, or other suitable connection.

However, an Internet server or client is typically not aware of its geographic location or the geographic location of the other servers and clients with which it is communicating. Rather, Internet servers and clients communicate with one another using Internet Protocol addresses that are not tied to geographic location.

### SUMMARY

The disclosure is directed to a partner network including multiple partner devices. Some partner devices are location aware, meaning that the device is configured to track its own location. Examples of location aware devices include cell phones, GPS systems, and other similar systems. Some other example partner devices depend upon a user to input location information.

Some example partner devices remain connected to the network whether or not a user is present. Such partner devices constantly gather data and transmit the data to the network.

Some example partner devices are configured to automatically obtain data of one or more types. Some other example partner devices connect and disconnect from the network at a request of the user.

According to one aspect, partner devices obtain location-specific data. In one embodiment, the partner devices transmit the obtained data to other partner devices. In another embodiment, the partner devices transmit the data to a hub.

According to another aspect, one or more databases store information obtained by the partner devices. In some embodiments, the databases index the information. In one embodiment, the databases index the information by location. In another embodiment, the databases index the information by type of information. In yet another embodiment, the databases index the information by partner device.

### BRIEF DESCRIPTION OF THE DRAWINGS

FIG. 1 illustrates a schematic of one exemplary embodiment of a partner network including multiple interconnected partner devices according to one embodiment of the present disclosure;

FIG. 2 illustrates a block diagram of an example hardware and operating environment in which different embodiments of the present disclosure can be practiced;

FIG. 3 illustrates a partner device configured to execute partner software according to one embodiment of the present disclosure;

FIG. 4 illustrates a partner device configured to execute an obtain module and a display module for obtaining and displaying data, respectively, according to one embodiment of the present disclosure;

FIG. 5 illustrates a first partner device and a second partner device configured according to one embodiment of the present disclosure;

FIG. 6 illustrates an operation flow by which a partner device can request, receive, and display location-specific information according to one embodiment of the present disclosure;

FIG. 7 illustrates an operation flow by which a partner device receives a request for data, obtains the requested data, and transmits the requested data back to the requesting device according to one embodiment of the present disclosure;

FIG. 8 illustrates an operation flow depicting a method for iteratively obtaining data and transmitting the data to a data storage unit according to one embodiment of the present disclosure;

FIG. 9 illustrates an operation flow depicting a method for receiving and storing data from at least one partner device according to one embodiment of the present disclosure;

FIG. 10 illustrates an operation flow by which a partner device requests location-specific data from a data storage unit according to one embodiment of the present disclosure;

FIG. 11 illustrates an operation flow by which a data storage unit receives a request for data from another partner device according to one embodiment of the present disclosure;

FIG. 12 illustrates one exemplary operation flow for receiving, analyzing, and indexing information from one or more partner devices according to one embodiment of the present disclosure;

FIG. 13 illustrates an example embodiment of a partner network including multiple partner devices sharing information with each other via a hub according to one embodiment of the present disclosure;

FIG. 14 illustrates an example embodiment of a partner network including multiple partner devices sharing information according to one embodiment of the present disclosure; and

FIG. 15 illustrates an operation flow for a process for obtaining data and displaying data to another partner device according to one embodiment of the present disclosure.

### DETAILED DESCRIPTION

In the following description of preferred embodiments, reference is made to the accompanying drawings that form a part hereof, and in which is shown by way of illustration specific embodiments in which the invention may be practiced. It is understood that other embodiments may be utilized and changes may be made without departing from the scope of the present disclosure.

In general, the present disclosure describes methods and systems for distributing location-specific information. More particularly, the software and systems include a network having a plurality of users. Each user connects to the network with a location-aware device. Each device functions as both a source of and recipient for location-specific information.

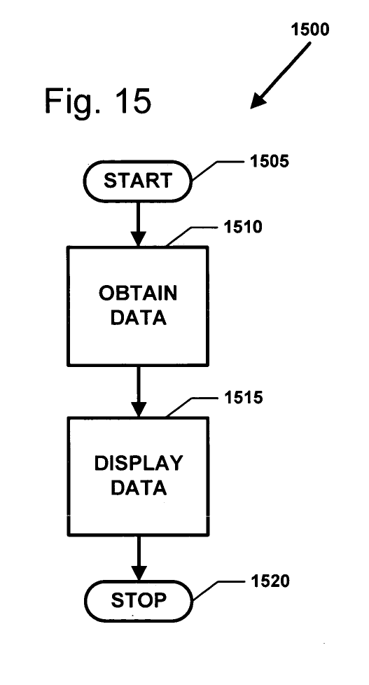

Referring to FIG. 15, in some embodiments, a partner device is configured to obtain and display information. FIG. 15 illustrates an operation flow for a process 1500 for obtaining and displaying information. The process 1500 begins at a start module 1505 and proceeds to an obtain operation 1510. The obtain operation 1510 obtains information associated with at least one location. In some embodiments, the obtain operation 1510 obtains the information from an area surrounding the partner device. In other embodiments, the obtain operation 1510 obtains the information from a user. In still other embodiments, the obtain operation 1510 obtains the information from another partner device. A display operation 1515 displays the obtained information to a user. The process 1500 ends at a stop module 1520.

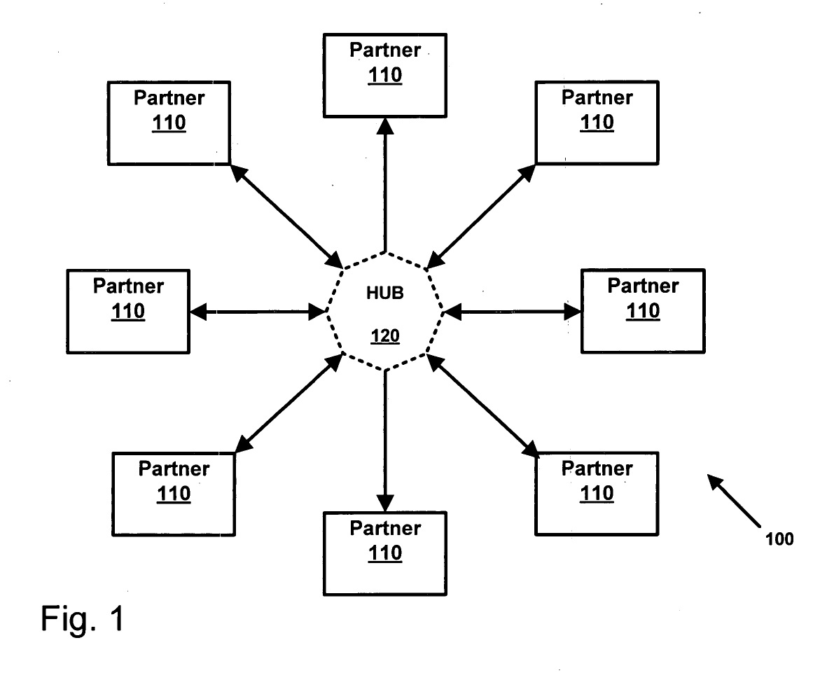

Referring now to FIG. 1, a partner network 100 according to one example embodiment of the present disclosure is illustrated. FIG. 1 illustrates a schematic of a partner network 100 including a plurality of interconnected partner devices 110. According to some embodiments, each partner device 110 communicates directly with other partner devices 110. According to other embodiments, the partner devices 110 communicate with one another using a hub 120. The partner devices 110 could also communicate using a network such as the Internet.

The hub 120 receives and transmits requests for data among the various partner devices 110. The hub 120 also receives and transmits data transmissions among the various partner devices 110. In some embodiments, the hub 120 includes a data storage unit for storing and indexing location-specific data. In one such embodiment, the hub 120 includes a central server system. In another embodiment, the hub 120 includes a distributed server system.

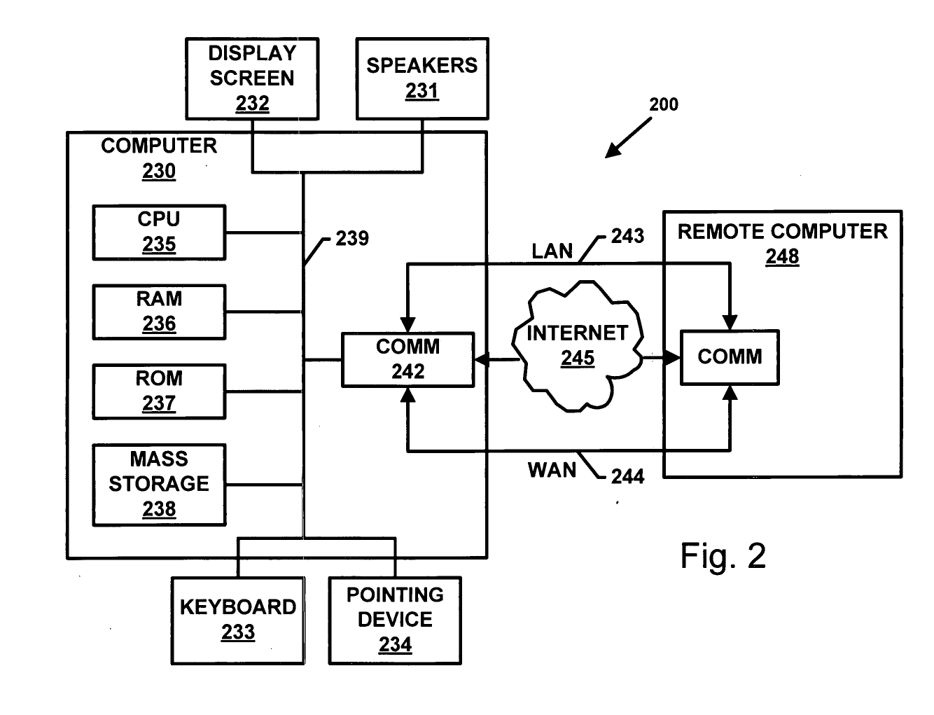

Referring to FIG. 2, a block diagram of an example hardware and operating environment 100 in which different embodiments of the disclosure can be practiced is illustrated. Some embodiments of the present disclosure are described in terms of a computer executing computer-executable instructions. However, some embodiments of the present disclosure can be implemented entirely in computer hardware in which the computer-executable instructions are implemented in read-only memory. Some other embodiments of the present disclosure can also be implemented in client/server computing environments where remote devices, linked through a communications network, perform tasks. Program modules can be located in both local and remote memory storage devices in a distributed computing environment.

A computer 230 is operatively coupled to a speaker 231, a display device 232, a keyboard 233, and a pointing device 234. The computer 230 includes a processing unit 235, such as a processor commercially available from Intel®, Motorola®, Cyrix® and other such companies, random-access memory (RAM) 236, read-only memory (ROM) 237, and one or more mass storage devices 238, and a system bus 239, that operatively couples various system components including the system memory to the processing unit 235. Mass storage devices 238 are more specifically types of nonvolatile storage media and can include a hard disk drive, a floppy disk drive, an optical disk drive, and a tape cartridge drive. The memory 236, 237 and mass storage devices 238 are types of computer-readable media. A user can enter commands and information into the computer 230 through input devices such as a pointing device 234 and a keyboard 233. Other input devices (not shown) can include a microphone, joystick, game pad, satellite dish, digital camera, digital camcorder, scanner, or the like. The processing unit 235 executes computer programs stored on the computer-readable media. Embodiments of the present disclosure are not limited to any particular type of computer 230. In varying embodiments, the computer 230 includes a PC-compatible computer, a MacOS®-compatible computer or a UNIX-compatible computer. The construction and operation of such computers are well known within the art.

Furthermore, computer 230 can be communicatively connected to the Internet 245 via a communication device 242. Internet connectivity is well known within the art. In one example embodiment, the communication device 242 is a modem that responds to communication drivers to connect to the Internet via what is known in the art as a “dial-up connection.” In another example embodiment, the communication device 242 is an Ethernet or similar hardware (network) card connected to a local-area network (LAN) that itself is connected to the Internet via what is known in the art as a “direct connection” (e.g., T1 line, etc.). In yet another example embodiment, the communication device 242 includes a wireless modem and hub to connect to the Internet via what is known in the art as a “wireless connection.”

The computer 230 can be operated using at least one operating environment to provide a graphic user interface including a user-controllable pointer. Such operating environments include operating systems such as versions of the Microsoft Windows® and Apple MacOS® operating systems well known in the art. Embodiments of the present disclosure are not limited to any particular operating environment, however, and the construction and use of such operating environments are well known within the art. The computer 230 can have at least one web browser application program executing within at least one operating environment, to permit users of the computer 230 to access an intranet or the Internet 245 as addressed by a Universal Resource Locator (URL) addresses. Such browser application programs include Netscape Navigator® and Microsoft Internet Explorer®.

Display device 232 permits the display of information, including computer, video, textual, and other information, for viewing by a user of the computer. Embodiments of the present disclosure are not limited to any particular display device 232. Such display devices include cathode ray tube (CRT) displays (monitors), as well as flat panel displays such as liquid crystal displays (LCD's). Display device 232 is connected to the system bus 239. In addition to a monitor, example computers can typically include other peripheral input/output devices (not shown) such as printers, speakers, pointing devices, and a keyboard. Speaker 231 enables audio output of signals. Speaker 231 is also connected to the system bus 239. Pointing device 234 permits the control of the screen pointer provided by the graphic user interface (GUI) of operating systems such as versions of Microsoft Windows®. Embodiments of the present disclosure are not limited to any particular pointing device 234. Such pointing devices include mouse devices, touch pads, trackballs, remote controls and point sticks. Finally, keyboard 233 permits entry of textual information into computer 230, as known within the art, and embodiments of the present disclosure are not limited to any particular type of keyboard.

The computer 230 can operate in a networked environment using logical connections to one or more remote computers, such as remote computer 248. Logical connections are achieved via a communication device coupled to, or a part of, the computer 230. Embodiments of the present disclosure are not limited to a particular type of communications device. The remote computer 248 can be another computer, a server, a router, a network PC, a client, a peer device, a mobile device such as a cell phone or PDA, or any other suitable network node. The logical connections depicted in FIG. 2 include a local-area network (LAN) 243 and a wide-area network (WAN) 244. Such networking environments are commonplace in offices, enterprise-wide computer networks, intranets and the Internet.

When used in a LAN-networking environment, the computer 230 and remote computer 248 are connected to the local network 243 through a network interface or adapter, which is one type of communications device 242. When used in a conventional WAN-networking environment, the computer 230 and remote computer 248 communicate with a WAN 244 through modems, which are another type of communications device 242. The modem of computer 230, which can be internal or external, is connected to the system bus 239. In a networked environment, program modules depicted relative to the computer 230, or portions thereof, can be stored in the remote memory storage device.

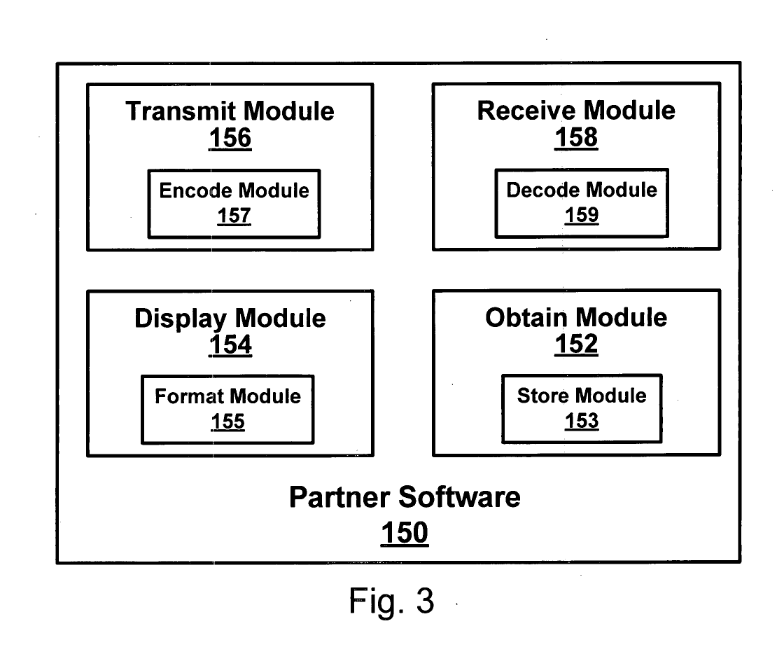

Referring to FIG. 3, some example embodiments of a partner device, such as the partner device 110 of FIG. 1, are configured to execute partner software 150. Some example embodiments of partner software 150 include an obtain module 152, a display module 154, a transmit module 156, and a receive module 158. The obtain module 152 enables the partner device to obtain data from an area surrounding the partner device. In some embodiments, the obtain module 152 automatically obtains data. In other example embodiments, the obtain module 152 obtains data when prompted by a user. In one embodiment, the partner device further includes a store module 153 for storing the obtained data.

In some example embodiments, the display module 154 enables the partner device to display location-specific data to a user of the partner device. Examples of displaying data include presenting graphical and/or textural information on a display screen and playing audio files on the partner device. In one example embodiment, the partner device includes a format module 155 for formatting the data for display.

In some example embodiments, the transmit module 156 transmits data. In other example embodiments, the transmit module 156 requests data. In still other example embodiments, the transmit module 156 transmits both data and requests for data. For example, in one embodiment, the transmit module 156 transmits data to a hub, such as hub 120 of FIG. 1. In another example embodiment, the partner device includes an encode module 157 for encoding the data for transmission. Examples of encoding data for transmission include compressing the data, encrypting the data, and performing other operations to otherwise alter and prepare the data for transmission.

In some example embodiments, the receive module 158 receives transmitted data. In other example embodiments the module 158 receives requests for data. In one example embodiment, the partner device receives data from a hub, such as hub 120 of FIG. 1. In another example embodiment, the partner device receives a request for data from the hub. In one example embodiment, the partner device includes a decode module 159 for decoding received data. Examples of decoding received data include decompressing the data, decrypting the data, and performing other operations to otherwise alter the received data from a transmitted format to a displayable/storable format.

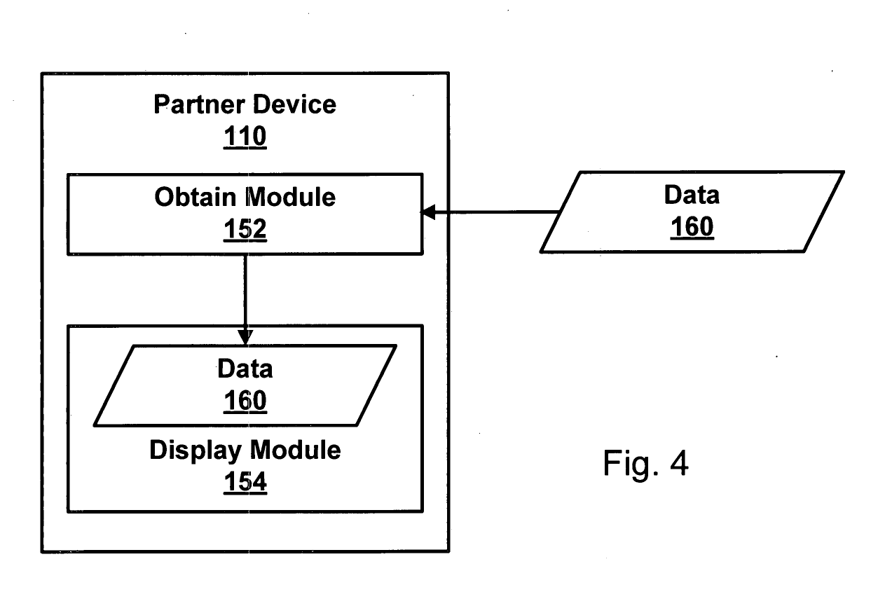

Referring to FIG. 4, one exemplary embodiment of a partner device, such as the partner device 110 of FIG. 1, obtains data and displays the data to a user. FIG. 4 illustrates a partner device 110 configured to execute an obtain module 152 and a display module 154 for obtaining and displaying data 160, respectively, as described in connection with FIG. 3.

In some example embodiments, the obtain module 152 automatically obtains data 160 from the surrounding area. Non-limiting examples of automatically obtained data 160 include temperature readings, geographic location readings (e.g., GPS readings), phenomenological readings, and other such data. In other example embodiments, the obtain module 152 obtains data 160 as a result of a user request (i.e., or command). Non-limiting examples of user requested data 160 include data typed in by a user, data downloaded by the user, and data accumulated by the user or the device, and still pictures, auditory recordings, and video recordings captured by the user. In other example embodiments, the obtain module 152 retrieves data 160 from a storage memory of the device, such as storage device 238 of FIG. 2.

The obtained data 160 is then passed to the display module 154, which displays the obtained data 160 to the user. In some example embodiments, the display module 154 displays textual, tabular, or graphic image data on a display screen, such as display screen 232 of FIG. 2. In other example embodiments, the display module 154 displays audio data using speakers, such as speakers 231 of FIG. 2. In still some other embodiments, the display module 154 displays multi-media data (i.e., video and sound).

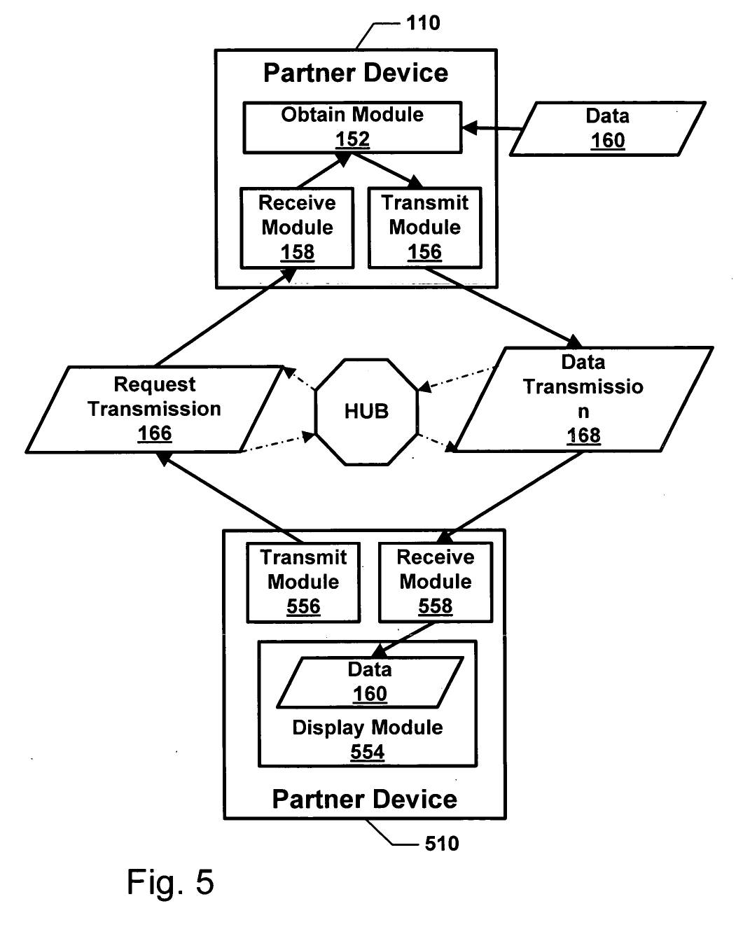

Referring to FIG. 5, in some example embodiments, a first partner device, such as the partner device 110 of FIG. 1, obtains location-specific information and a second partner device displays the obtained information. FIG. 5 illustrates a first partner device 110 and a second partner device 510. Each partner device 110, 510 includes a transmit module 156, 556, respectively, and a receive module 158, 558, respectively. The first partner device 110 further includes an obtain module 152 for obtaining location-specific data 160. The second partner device 510 further includes a display module 554, which is similar to display module 154 of FIG. 3, for displaying the obtained data 160.

In one example embodiment, depicted in solid lines, the transmit module 556 of the second partner device 510 transmits a data request transmission 166 to the first partner device 110. In another example embodiment, depicted in dashed lines, the transmit module 556 transmits the data request transmission 166 to a hub, such as hub 120 of FIG. 1, which routs the data request 166 to an appropriate partner device, such as partner device 110. The data request transmission 166 includes a request that location-specific data 160 be transmitted to the second partner device 510.

The receive module 158 of partner device 110 receives the data request transmission 166, and communicates with the obtain data module 152. The obtain data module 152 obtains the location-specific data 160 requested by the second partner device 510. In one embodiment, depicted in solid lines, the transmit module 156 of the first partner device 110 transmits the data 160 in a data transmission 168 to the second partner device 510. In another embodiment, depicted in dashed lines, the transmit module 156 of the first partner device 110 transmits the data 160 to the hub 120 and the hub 120 transmits the data 160 to the second partner device 510. The receive module 558 of the second partner device 510 receives the data transmission 168 sent by the first partner device 110. The display module 554 of the second partner device 510 displays the data 160 to the user of the second partner device 510.

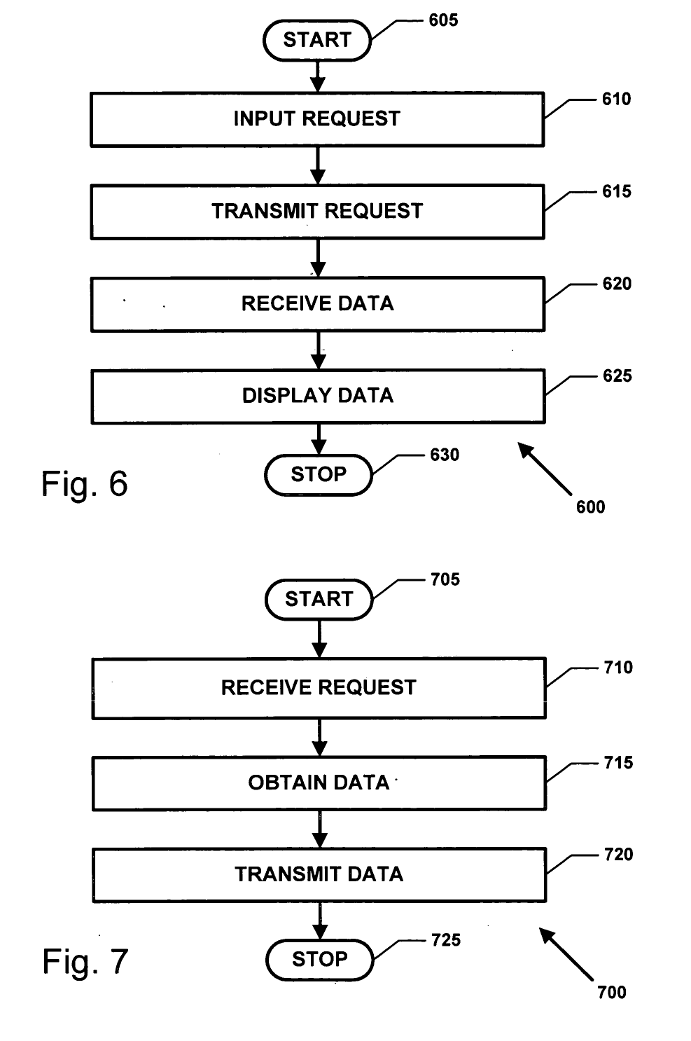

Referring now to FIGS. 6-7, a first partner device may deterministically request and receive location-specific data from a hub, such as hub 120 of FIG. 1, or a second partner device, such as partner device 510 of FIG. 5. FIG. 6 illustrates an operational flow 600 by which a partner device, such as partner device 110 of FIG. 5, can request, receive, and display location-specific information. The operational flow 600 begins at a start module 605 and proceeds to an input operation 610. In some example embodiments, the input operation 610 enables a user to enter a data request for location-specific information, such as data request 166 of FIG. 4. In other examples, the request for location-specific information is automatically generated.

A transmit operation 615 transmits the request for location-specific information to a hub, such as hub 120 of FIG. 5, or other partner device, such as partner device 510 of FIG. 5. Receive operation 620 receives the requested data from the hub or partner device and a display operation 625 displays the received information. In some embodiments, the receive operation 620 receives the requested data from the partner device that obtained the data. In some other embodiments, the receive operation 620 receives the requested data from a hub on which the requested data had been stored. In still other embodiments, the receive operation receives the requested data from a partner device storing the data. The operational flow 600 ends at a stop module 630.

FIG. 7 illustrates an operational flow for a process 700 by which a partner device, such as partner device 110 of FIG. 5, receives a request for data, obtains the requested data, and transmits the requested data back to the requesting device. The operational flow 700 begins at a start module 705 and proceeds to a receive operation 710. The receive operation 710 receives a request for location-specific data. In some example embodiments, the request originates from another partner device, such as partner device 510 of FIG. 5. In other example embodiments, the request originates from the hub. Generally, the location to which the data is specific corresponds with a current or near-by location of the receiving partner device.

An obtain operation 715 obtains the requested information from the surrounding area or from a memory storage unit. In some example embodiments, the obtain operation 715 is performed automatically without user input. For example, in one example embodiment, the partner device obtains a temperature reading of the surrounding area. In other example embodiments, however, the obtain operation 715 obtains information from a user or at the request of the user. For example, in one example embodiment, a user inputs for transmission a textual message describing a characteristic of the area surrounding the user. In another example embodiment, a user inputs for transmission a textual message describing an event happening at or near the area surrounding the user. The transmit operation 720 transmits the obtained data to the requesting partner device. The operational flow 700 ends at a stop module 725.

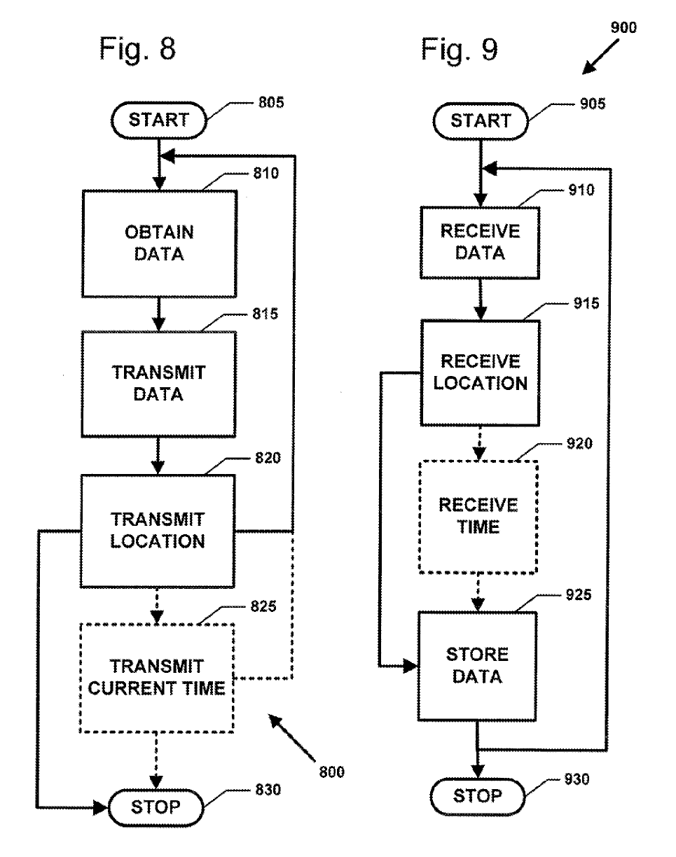

Referring now to FIGS. 8-11, in some example embodiments, data is repeatedly obtained by at least one partner device in at least one area and stored for later retrieval by one or more partner devices. FIG. 8 illustrates an operational flow for a process 800 depicting a method for iteratively obtaining location-specific data and transmitting the data to a data storage unit, such as hub 120 of FIG. 1. The operational flow 800 begins at a start module 805 and proceeds to an obtain operation 810, which obtains location-specific data from the surrounding area.

In some example embodiments, a partner device continuously obtains a particular type of information. For example, in one example embodiment, a partner device obtains the temperature of the partner device's immediate surroundings. In other example embodiments, a partner device obtains multiple types of information. For example, in one example embodiment, a partner device may obtain both audio and video recordings of the partner device's surroundings. In still other example embodiments, the partner device obtains data from the surrounding area at predetermined times or when located in predetermined areas.

A transmit data operation 815 transmits the obtained data to a data storage unit. In some example embodiments, the data storage unit is another partner device. In other example embodiments, the data storage unit is a central networked server having access to the partner network. In still other example embodiments, the data storage unit is a distributed server system having access to the partner network.

A transmit location operation 820 transmits a geographic location to the data storage unit. In some embodiments, the geographic location is the current geographic location of the partner device obtaining the location-specific data. In other example embodiments, the geographic location is the location at which the data was obtained. In still other example embodiments, the geographic location is a location entered by a user.

An optional transmit time operation 825 transmits a timestamp to the data storage unit. In some example embodiments, the timestamp indicates the time at which the data was obtained. In other example embodiments, the timestamp indicates the time at which the data was transmitted. The operational flow 800 ends at a stop module 830. In some example embodiments, multiple partner devices located in multiple geographical areas iteratively perform the operations of the process 800.

FIG. 9 illustrates an operational flow for a process 900 depicting a method for receiving and storing data from at least one partner device. The process 900 begins at a start module 905 and proceeds to a receive data operation 910. In some example embodiments, the receive data operation 910 receives data from the partner device that obtained the received data. In other example embodiments, the receive data operation 910 receives data from a hub, such as hub 120 of FIG. 1. A receive location operation 915 receives a geographic location transmitted by the partner device or hub. An optional receive timestamp operation 920 receives a timestamp transmitted by the partner device or hub.

An index operation 925 stores the transmitted data in a data storage unit. In some example embodiments, the index operation 925 stores the transmitted data based on the transmitted geographic location. In other example embodiments, the index operation 925 also stores the transmitted data based on the timestamp. In still other example embodiments, the index operation 925 correlates the partner device obtaining the transmitted data with the stored transmitted data. Preferably, the transmitted data is stored in a searchable format.

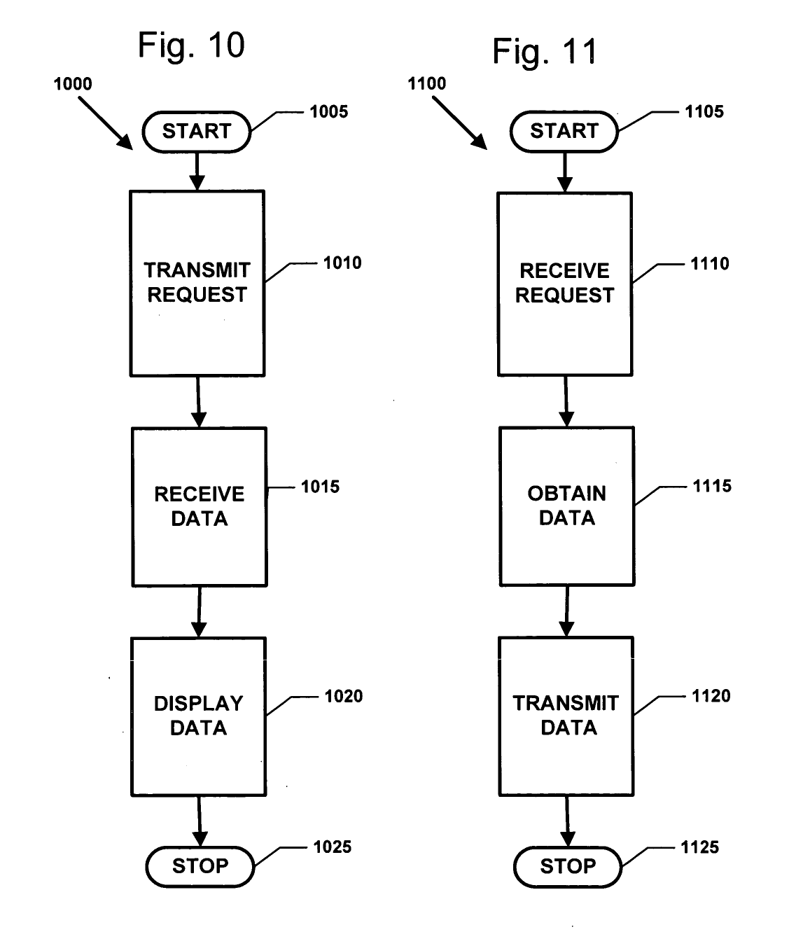

Referring now to FIG. 10, FIG. 10 illustrates an operational flow process 1000 by which a partner device requests location-specific data from a data storage unit. The process 1000 begins at module 1005 and proceeds to a transmit operation 1010, which transmits a request for information to a data storage unit. In one example embodiment, the request includes a request for all data pertaining to a particular location. In another example embodiment, the request includes a request for a particular type of data pertaining to a particular location. In yet another embodiment, the request includes a request for data associated with a particular location and a particular time.

A receive operation 1015 receives the requested data from the data storage unit. In some example embodiments, the receive operation 1015 receives all data specific to a particular location. In other example embodiments, the receive operation 1015 receives all data specific to a particular location and timestamp. In still other embodiments, the receive operation 1015 receives a particular type of data pertaining to a particular location. Of course, the receive operation 1015 can receive any data requested by the user.

A display operation 1020 displays the received data to a user of the partner device. In some example embodiments, the display operation 1020 displays image and textual data to a user via a display screen, such as display screen 232 of FIG. 2. In some other example embodiments, the display operation 1020 displays audio data to the user via one or more speakers, such as speakers 231 of FIG. 2. The process 1000 ends at a stop module 1025.

Referring now to FIG. 11, FIG. 11 illustrates an operational flow for a process 1100 by which a data storage unit receives a request for data from another partner device. The operational flow 1100 begins at a start module 11 05 and proceeds to a receive operation 1110, which receives a request for data from a partner device. In one example embodiment, the request includes a particular geographic location to which the requested data is specific. In another example embodiment, the request includes a particular time to which the requested data is specific. In yet another example embodiment, the request includes a category to which the requested data is specific.

A retrieve operation 1115 obtains the requested data from a data storage unit. In some example embodiments, the retrieve operation 1115 includes retrieving the data from a storage unit on a server system. In one example embodiment, the retrieve operation 1115 includes retrieving the data from a database on a distributed server network. In other example embodiments, the retrieve operation 1115 retrieves data from a partner device through a request for data. Operational flow 1100 ends at a stop module 1125.

In some embodiments, the retrieve operation 1115 retrieves raw data obtained by one or more partner devices. In other embodiments, the retrieve operation 1115 retrieves processed data that has been compiled, analyzed, reformatted, or otherwise altered. For example, the retrieved data may include information determined based on the raw data retrieved by the partner devices.

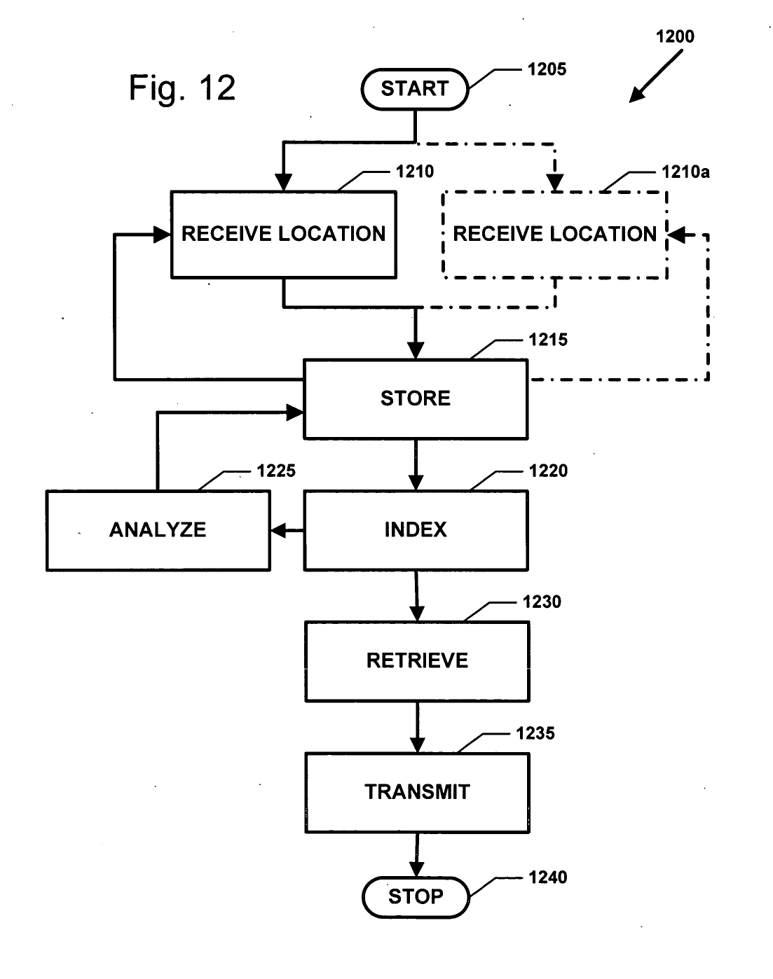

FIG. 12 illustrates an operational flow for a process 1200 by which a partner device or hub can analyze and store raw data obtained by the partner devices in a partner network. The process 1200 begins at a start module 1205 and proceeds to a receive operation 1210. The receive operation 1210 receives a data transmission from a partner device. Preferably, the data transmission includes raw data and an indication of a geographic location associated with the raw data.

In some embodiments, depicted in solid lines, a data transmission is received from only one partner device. In other embodiments, data transmissions for a particular location are received from multiple partner devices. For example, in one embodiment, multiple devices are located in the same general location at approximately the same time and each partner device transmits information regarding a location. In other embodiments, each partner device is located in the same general location at different times and transmits information associated with the location at different times.

The process 1200 proceeds from the receive location operations 1210, 1210a to a store operation 1215. The store operation 1215 encodes the received location-specific data in a memory storage unit, such as the data storage unit 238 of FIG. 2. Generally, the store operation 1215 saves the receipt data in a searchable format. The process 1200 can then cycle back to the receive location operation 1210 if the partner device provides further location-specific information. Alternatively, the process 1200 proceeds to an index operation 1220. The index operation 1220 provides an interface through which a user can access the stored location-specific information. In some embodiments, the index operation 1220 provides a search function for locating desired information. In one example embodiment, the search function enables a user of a partner device to find and access information based on the geographic location with which the information is associated. In another embodiment, the search function enables a user of a partner device to locate and access information based on a category of information. In still other embodiments, the search function enables a user to access information associated with two or more geographic locations. In other embodiments, the index operation 1220 creates a database or other record keeping system to log the type of information received.

In some embodiments, the process 1200 proceeds from the index operation 1220 to an analyze operation 1225. The analyze operation 1225 processes the raw information received from the partner devices to create additional information. For example, the analyze operation 1225 can compile location-specific data and combine the data in a format more readily understandable to a user of a partner device. In some embodiments, the analyze operation 1225 can make determinations and conclusions based on the raw data received from the partner devices. The store operation 1215 encodes the processed information which is then indexed by the index operation 1220.

Alternatively, the stored information is not further analyzed and process 1200 proceeds from the index operation 1220 to a retrieve operation 1230. The retrieve operation 1230 occurs when at least one partner device requests information stored in the data storage unit. In some embodiments, the partner device utilizes a search function provided by the index operation 1220 and requests the information discovered using the search function. In other embodiments, a partner device sends a data request including a specific location to the data storage unit. After the retrieve operation 1230 has found and accessed the requested information, a transmit operation 1235 sends the requested information to the requesting partner device. In some embodiments, however, the steps of process 1200 can be carried out by a partner device and the transmit operation 1235 can transmit information to a hub, such as hub 120 of FIG. 1. Process 1200 ends at a stop module 1240.

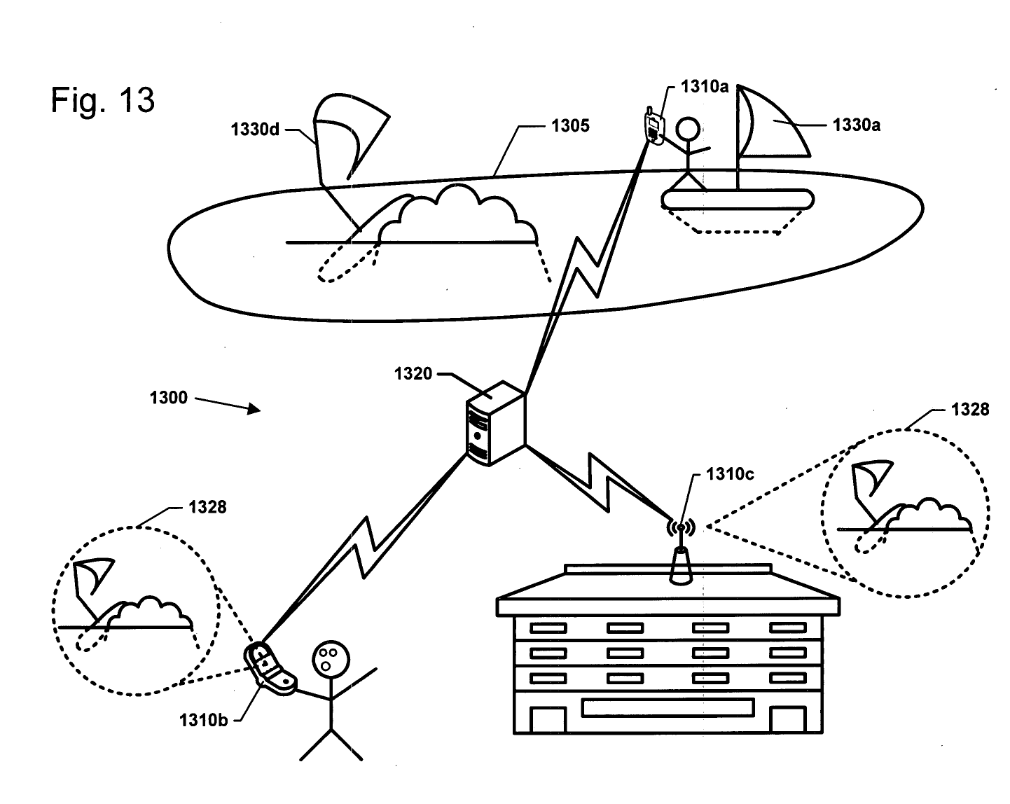

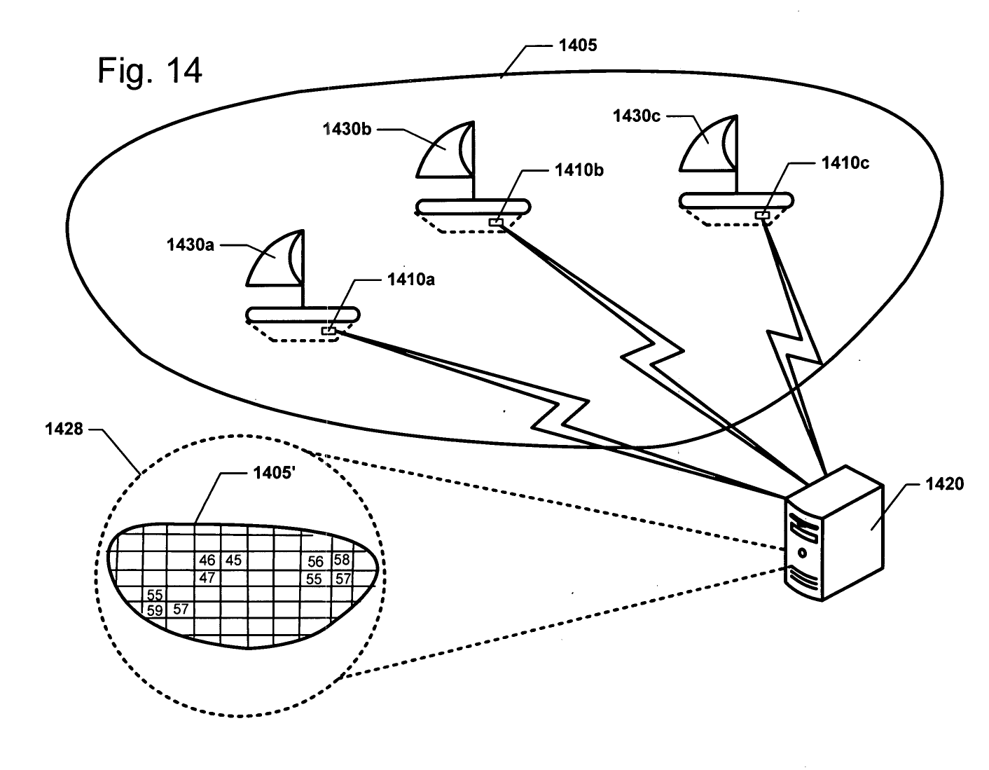

Referring now to FIGS. 13-14, the ideas discussed above can be made clearer through some example applications. FIG. 13 illustrates one exemplary embodiment of a partner network 1300 including multiple partner devices 1310a-1310c communicating with each other via a hub 1320. Of course, in other example embodiments, partner devices 1310a-1310c communicate with each other directly. In some example embodiments, the partner devices 1310a-1310c are location aware (i.e., each device can determine its geographic location via global positioning, triangulation, or other such means).

In some example embodiments, partner devices 1310a-1310c include mobile devices, such as cellular phones, personal digital assistants (PDA's), digital cameras, digital video recorders, position location devices (e.g., GPS systems), and other such portable electronic devices configured to communicate over the partner network 1300. However, the partner devices 1310a-1310c may also include devices fixedly mounted to a building or vehicle.

In the example embodiment illustrated in FIG. 13, partner device 1310a has the ability to obtain graphic image information. A mobile partner device 1310b and a stationary partner device 1310c are configured to display graphic image data. Of course, each of these partner devices 1310a-1310c in some embodiments could also be configured to obtain and display textual, auditory, and multi-media information. Each partner device 1310a-1310c is communicatively coupled to a hub 1320 via a wireless connection. The hub 1320 is configured to receive data transmissions from each of the partner devices 1310a-1310c, to transmit data and data requests to each of the partner devices 1310a-1310c, and to store and retrieve data.

The partner network, such as partner network 1300, can be used to distribute location-specific news to multiple partner devices. For example, in the illustrated embodiment, the user of partner device 1310a, located on a boat 1330a, on a lake 1305, witnesses a boat crash on the lake 1305 and records an image 1328 of the boat 1330d sinking, using his partner device 1310a. The image 1328 of the sinking boat 1330d and a geographic location associated with the image 1328 are transmitted to the hub 1320.

Referring now to FIGS. 12 and 13, the hub 1320 implements the process 1200 described in FIG. 12. The receive operation 1210 of process 1200 receives the image 1328 of the sinking boat 1330d transmitted by the partner device 1310a. The receive operation 1210 also receives the geographic location associated with the sinking boat. In one example embodiment, the receive operation 1210 receives indicia of the geographic location where the boat 1330d is sinking. In some embodiments, the receive operation 1210 further receives textual and/or auditory comments provided by the user of partner device 1310a elaborating on the image 1328 of the boat crash.

The store operation 1215 of the hub 1320 encodes the data received from the partner device 1310a in memory. The index operation 1220 enables other partner devices, such as partner devices 1310b and 1310c, to search for and request access to the stored information regarding the boat crash. In other embodiments, the stored information might automatically be sent to partner devices 1310b and 1310c. In some embodiments, the index operation 1220 will enable a partner device, such as partner device 1310b, to search for any information associated with the lake 1305. In other embodiments, the index operation 1220 will enable a partner device, such as partner device 1310c, to search for any information pertaining to boat crashes. In one example embodiment, the index operation 1220 enables the partner device 1310c to search for any information pertaining to boat crashes in a geographic area including the lake 1305.

The retrieve operation 1230 and the transmit operation 1235 of the hub 1320 enable the partner devices, such as partner devices 1310b and 1310c, to access the stored information pertaining to the boat crash. Each partner device 1310b, 1310c is configured to display the information retrieved from the hub 1320 as shown in FIG. 13. In some embodiments, the partner devices, such as partner device 1310b, are mobile, enabling a user to access the obtained information from any location. In other embodiments, the partner devices, such as partner device 1310c, are stationary. In one example embodiment, the stationary partner device 1310c is a news station.

Referring now to FIG. 14, another example application of information dissemination using a partner network is provided. FIG. 14 illustrates multiple partner devices 1410a-1410c attached to boats 1430a-1430c. The boats 1430a-1430c are located at different sections on a lake 1405. Each partner device 1410a-1410c is coupled to the corresponding boat 1430a-1430c beneath the water level and is configured to automatically and repeatedly obtain temperature information. Of course, other information can also be shared, such as information obtained by depth sounders. As the boats 1430a-1430c travel around the lake 1405, the partner devices 1410a-1410c gather water temperature information from different sections of the lake. The temperature of the water currently surrounding the partner device 1410a-1410c is repeatedly transmitted to the central hub 1420.

In some embodiments, the hub 1420 implements the process 1200 described with respect to FIG. 12. The receive operation 1210 of the hub 1420 receives the temperature information and an indication of a geographic location associated with the temperature information from each partner device 1410a-1410c. The store operation 1215 and the index operation 1220 encode the received operation in memory in a searchable format.

The analyze operation 1225 of the hub 1420 processes the raw information received from the partner devices 1410a-1410c. In some example embodiments, the analyze operation 1225 compiles the temperature information gathered by the partner devices 1410a-1410c into a data map as shown at indication number 1428. The map 1428 depicts the lake 1405′ and superimposes a grid dividing the lake 1405′ into sections. The map 1428 displays a water temperature in each section for which a temperature is known.

As new information is received from the partner devices 1410a-1410c, the analyze operation 1225 of the hub 1420 adds to the data map 1428. The updates to the map 1428 are stored and indexed by the hub 1420 to enable one or more partner devices (not shown) to access the updated copy of the map 1428. Of course, the data map 1428 can take any form and is not limited to a grid representation. In other embodiments, the analyze operation 1225 of the hub 1420 can compile the water temperature information into a tabular form or an auditory form. In still other embodiments, a partner device (not shown) can retrieve the water temperature information provided by a specific partner device such as partner device 1410a or water temperature information regarding a particular section of the lake 1405.

In some embodiments, a partner device, such as partner device 1410a, will also have a user interface enabling the user to enter additional location-specific information. For example, in one embodiment, a fisherman on boat 1430a may input into partner device 1410a the number of fish caught at a particular location. This information can be transmitted to the hub 1420 along with or separate from the water temperature information being obtained from the partner device 1410a. In one example embodiment, the analyze operation 1225 of the hub 1420 compiles the number of fish caught and correlates such data with the water temperature information for a particular location. The correlated information can be stored, indexed, and retrieved by the hub 1420, for example, by using the steps of the process 1200 described with reference to FIG. 12.

In some embodiments, displayed information, such as the map 1428, includes links to other displayed information. For example, in one embodiment, the map 1428 has at least one link to a picture of the fish caught at least one particular location. After accessing the map, partner devices can select the link to display the picture. In another embodiment, the pictures are indexed and a partner device accesses the pictures by searching for them. In yet another embodiment, the pictures are included in the map 1428, instead of links to the pictures.

The above specification, examples and data provide a complete description of the manufacture and use of the composition of the invention. Since many embodiments of the invention can be made without departing from the spirit and scope of the invention, the invention resides in the claims hereinafter appended.

1. An information distribution system comprising:
a first portable partner device, the first partner device configured to:
obtain weather information from surroundings of the first partner device; and
transmit the obtained information; and
a second portable partner device, the second partner device configured to:
receive the information transmitted by the first partner device; and
display the information received from the first partner device.

2. The system of claim 1, further comprising:
a plurality of partner devices, each partner device configured to execute partner software including an obtain module, a transmit module, a receive module, and a display module.

3. The system of claim 1, further comprising:
a hub coupled to the first and second partner devices, the hub configured to route information transmitted from the first partner device to the second partner device.

4. The system of claim 3, wherein the hub is further configured to store and index information obtained from the first partner device.

5. The system of claim 1, wherein the first partner device includes a cell phone.

6. A method of sharing information comprising:
obtaining information associated with a geographic location, the information comprising a weather related picture captured by a portable electronic device;
transmitting the information from the portable electronic device; and
transmitting indicia of the geographic location associated with the obtained information from the portable electronic device.

7. The method of claim 6, further comprising transmitting the information and the indicia to multiple partner devices.

8. The method of claim 6, further comprising storing the obtained information in a searchable format.

9. The method of claim 8, wherein the stored information is searchable by location.

10. The method of claim 6, further comprising indexing the information by category.

11. An information distribution system comprising a plurality of portable partner devices communicatively coupled to one another, each partner device being location aware, and each partner device being configured to obtain, display, transmit, and receive location-specific weather information.

12. The information distribution system of claim 11, further comprising a hub communicatively coupled to the plurality of partner devices.

13. The information distribution system of claim 12, wherein the hub is a central server.

14. The information distribution system of claim 12, wherein the hub is a distributed server system.

15. The information distribution system of claim 12, wherein the hub stores, indexes, and analyzes information obtained by one or more of the plurality of partner devices.

16. A method of sharing fishing information, the method comprising:
obtaining water temperature information for a plurality of locations within a lake;
obtaining information indicating a number of fish caught for at least some of the locations within the lake;
storing the water temperature information for the plurality of locations;
storing the information indicating the number of fish caught for the at least some of the locations; and
analyzing the water temperature information and the information indicating the number of fish caught including compiling the water temperature information and the information indicating the number of fish caught and creating a map of the lake, wherein the map indicates a water temperature for the plurality of locations and wherein the map indicates the number of fish caught for the at least some of the locations.

17. The method of claim 16, further comprising:
indexing by location the water temperature information;
indexing by location the information indicating the number of fish caught; and
indexing the map by location.

18. The method of claim 16, further comprising:
receiving a request from a partner device for water temperature information for at least some of the plurality of locations within the lake;
retrieving the water temperature information for the at least some of the plurality of locations within the lake; and
transmitting the water temperature information to the partner device.

19. The method of claim 16, further comprising:
receiving a request from a partner device for any information associated with the lake;
retrieving information associated with the lake including retrieving the water temperature information for the plurality of locations within the lake and retrieving the information indicating the number of fish caught for the at least some of the locations within the lake; and
transmitting the retrieved information to the partner device.

20. The method of claim 16, further comprising:
obtaining at least one picture of fish caught from locations within the lake;
storing the pictures of fish caught from the locations within the lake; and
analyzing the at least one picture of fish caught from the locations within the lake, including adding to the map links to the at least one picture, wherein a partner device can access the at least one picture by accessing the map and selecting the link.

21. A method of sharing information, the method comprising:
obtaining information related to the surroundings of a portable electronic device;
associating the information with a location at which the information was obtained, thereby creating a first portion of location-specific information;
wirelessly transmitting the first portion of location-specific information from the portable electronic device to a network;
wirelessly receiving a second portion of location-specific information on the portable electronic device from the network; and
displaying the second portion of location-specific information on the portable electronic device.

22. The method of claim 21, wherein at least one portion of the location-specific information is weather related.

23. The method of claim 21, wherein at least one portion of the location-specific information is a temperature.

24. The method of claim 21, wherein at least one portion of the location-specific information is a water temperature.

25. The method of claim 21, wherein at least one portion of the location-specific information is obtained automatically.

26. The method of claim 21, wherein at least one portion of the location-specific information is an image of weather phenomenon.

27. The method of claim 21, wherein at least one portion of the location-specific information is a video of weather phenomenon.

28. A method of sharing information, the method comprising:
automatically obtaining weather information from the surroundings of a portable electronic device;
associating the information with a location at which the information was obtained, thereby creating a first portion of location-specific information;
wirelessly transmitting the first portion of location-specific information from the portable electronic device to a network;
wirelessly receiving a second portion of location-specific information on the portable electronic device from the network; and
displaying the second portion of location-specific information on the portable electronic device.
